(19) United States
(12) Patent Application Publication
(10) Pub. No.: US 2014/0137226 A1
(43) Pub. Date: May 15, 2014

(54) Method and System for Processing Identity Information

(71) Applicant: Tencent Technology (Shenzhen) Company Ltd., Shenzhen (CN)

(72) Inventor: Ya Han, Shenzhen (CN)

(73) Assignee: Tencent Technology (Shenzhen) Company Ltd., Shenzhen (CN)

(21) Appl. No.: 14/160,191

(22) Filed: Jan. 21, 2014

(30) Foreign Application Priority Data
Jul. 20, 2011 (CN) 201110203944.5

(51) Int. Cl. H04L 29/06

(52) U.S. Cl. CPC H04L 63/0815
USPC 726/8

(57) ABSTRACT

A method for processing identity information may include: a first identity for logging into a first website is obtained; a user logs into a second website by using the first identity; a second identity for logging into the second website is obtained; a relation which associates the first identity with the second identity is established.

### CROSS-REFERENCE TO RELATED APPLICATIONS

The present disclosure is a continuation application of PCT/CN2012/077865 which claims priority of Chinese patent application No. 201110203944.5 titled “method and apparatus for processing identity information” and filed on Jul. 20, 2011 with the Patent Office of the People's Republic of China, the disclosure of which is incorporated by reference in its entirety.

### TECHNICAL FIELD

The present invention relates to network technology, and particularly, to a method and a system for processing identity information.

### BACKGROUND

A user generally registers an account in a website for identitying the user when using a service provided by the website. With the emerging of various websites capable of providing services in the network, more and more users receive services from the websites by registering accounts in the websites.

### SUMMARY

Various examples provide a method for processing identity information to provide a convenient mechanism for users to manage account information.

Various examples also provide a system for processing identity information to provide a convenient mechanism for users to manage account information.

A method for processing identity information may include:
obtaining a first identity which is used for logging into a first website;
logging into a second website by using the first identity;
obtaining a second identity for logging into the second website;
establishing a relation which associates the first identity with the second identity.

A system for processing identity information may include:
an obtaining module, configured to obtain a first identity which is used for logging into a first website;
a login module, configured to log into a second website by using the first identity;
wherein the obtaining module is further configured to obtain a second identity of a user for logging into the second website; and
a mapping module, configured to establish a relation which associates the first identity with the second identity.

According to the above method and system that bind identities, when a user logs into a second website by using a first identity, the first identity of the user is associated with a second identity of the user. As such, when the user logs into the second website again, the second identity of the user can be found out by using the first identity. When the first identity is used as a uniform ID in logging into the second website, the website can identity the user using the first identity is the user of the second identity when the user logs into the second website by using the first identity. Therefore, a registered user of a website may use a uniform ID to log into different websites, and it is convenient for a user to manage user accounts and to log into websites.

### BRIEF DESCRIPTION OF THE DRAWINGS

FIG. 1 is a flowchart illustrating a method for binding identities according to an example of the present disclosure;

FIG. 2 is a flowchart illustrating a method for binding identities according to an example of the present disclosure;

FIG. 3 is a flowchart illustrating a method for binding identities according to an example of the present disclosure;

FIG. 4 is a flowchart illustrating a method for binding identities according to an example of the present disclosure;

FIG. 5 is a schematic diagram illustrating a system for binding identities according to an example of the present disclosure;

FIG. 6 is a schematic diagram illustrating a system for binding identities according to an example of the present disclosure;

FIG. 7 is a schematic diagram illustrating a system for binding identities according to an example of the present disclosure.

### DETAILED DESCRIPTIONS

An open identity (Open ID) is used to link user systems of multiple websites. The open ID enables a user to log into multiple websites that support the open ID by using a uniform ID. This method are applied to new users only. If a user has already had an account in a website supporting open ID and have been using the account for acquiring services from the website, when the user logs into the website by using an open ID, the website cannot recognize the user using the open ID is the same user using the original ID, which seems to the user that the user registered a new ID in the website.

According to a method and a system for processing identity information associates a first identity of a user in a first website with a second identity of the user in a second website so that account information of the user in the first website is bound with that in the second website and it is easier for the user to manage the account information.

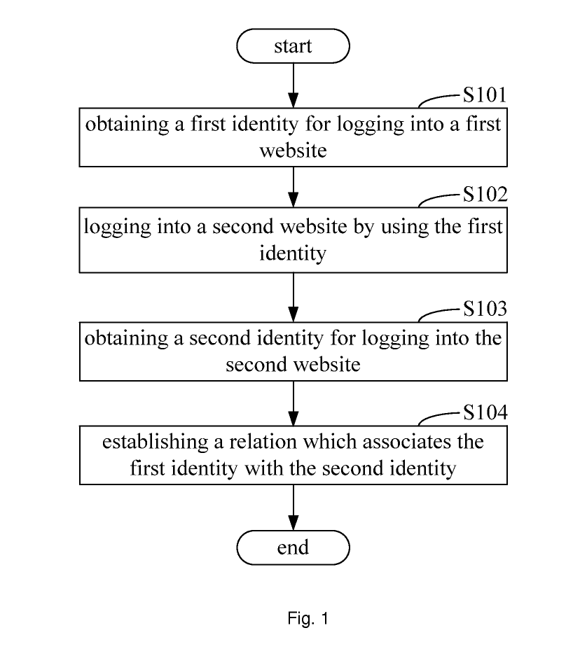

FIG. 1 is a flowchart illustrating a method for binding identities according to an example of the present disclosure. The method may include the following procedures.

In block S101, a first identity which is used for logging into a first website is obtained.

In an example, a user registers at a first website to obtain a first identity which is used for logging into the first website. In an example, the first website supports open ID.

In block S102, a second website is accessed by using the first identity.

In a conventional user login system, most websites only support login by users using identities provided by respective websites, i.e., a first identity can only be used for logging into a first website, and a second identity can only be used for logging into a second website, and a user cannot use a uniform identity to log into all of the websites, which is inconvenient for users. In an example of the present disclosure, a first website may be configured to be an open login platform, and a first identity established by the first website is a uniform user identity. A user may log into a second website which supports the open platform by using the first identity, i.e., the user is authenticated by using the first identity provided by the first website to log into the second website. The second website may be a completely different and independent website with respect to the first website, has a different user login system, provides different identities, and supports the open platform of the first website. For example, given the first website provides a register interface for a user and provides an open ID for a user according to register information submitted by the user, the first identity may be in a form of a web address, e.g., a uniform resource location (URL) or an XORP (extensible open router platform) Resource Locators (XRL). After registering in a website providing an open ID to obtain a first identity, a user may input the first identity and a password into a second website to log into the second website. The second website may be any website such as Yahoo. The first website serves as an open login platform and provides information for multiple second websites. A user may use the first identity to log into any website supporting the login platform without having to memorize login information for each of the second websites respectively.

In block S103, a second identity for logging into the second website is obtained.

In an example, the second identity may be an identity generated after the user registers in the second website. A webpage corresponding to the second identity can be retrieved after a successful login using the second identity in the second website.

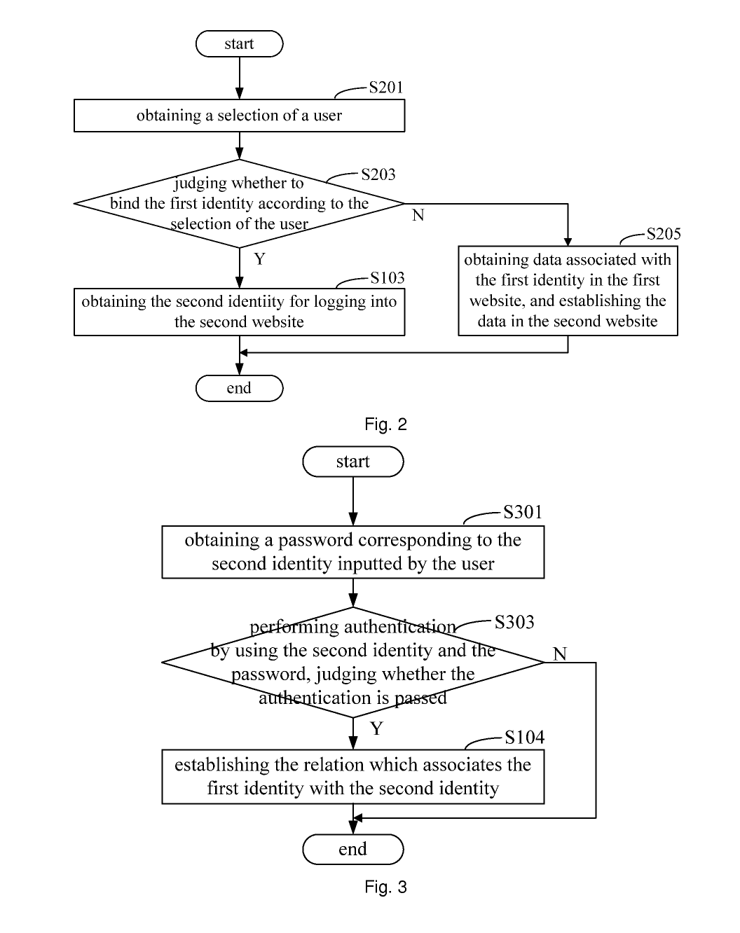

In an example, as shown in FIG. 2, before obtaining the second identity for logging into the second website, the method may also include the following procedures.

In block S201, a selection of the user is obtained.

In an example, the user may make a selection as to whether identity binding is to be performed in a selection interface provided by the second website.

In block S203, it is judged whether to associate the first identity with another identity according to the selection made by the user, and the procedure in block S104 is performed in response to a determination that the first identity is to be associated with another identity, or the procedure in block S205 is performed in response to a determination that the first identity is to be associated with another identity.

In an example, the judgment may be made according to an instruction triggered by a selection of the user. When it is determined that the first identity is to be bound with another identity, the procedure in block S104 is performed to establish a relation which associates the first identity with the second identity. When it is determined that the first identity is not to be bound with another identity, the first identity is directly regarded as the identity of the user in the second website. In an example, after the user is authenticated, a user interface corresponding to the first identity in the second website is provided. The second website may pop up a dialog box for the user. The dialog box may include two buttons, one indicates “auto binding” and the other indicates “binding manually”. When the user selects and clicks on the button indicating “binding manually”, the second website may pop up another dialog box prompting the user to input the second identity. The second identity is an identity of the user originated from the second website. When the user selects and clicks on the button indicating “auto binding”, the second website may take the first identity automatically as the identity of the user in the second website, obtain data associated with the first identity of the user in the first website, and take the data as the data associated with the first identity in the second website so that the user can only log into the second website by using the first identity.

In block S205, data associated with the first identity in the first website is obtained, and the data is established in the second website.

In an example, the data records a user name, a nickname and etc. of the user, and can be obtained from registration information of the user in the first website. The first identity serves as a new virtual user of the second website, thus it is necessary to obtain data associated with the first identity from the first website. Then the data obtained from the first website is established in the second website so that the first identity has the same user name and nickname in the second website as in the first website.

In an example, as shown in FIG. 3, after obtaining the second identity for logging into the second website, the method may also include the following procedures.

In block S301, a password corresponding to the second identity inputted by the user is obtained.

In block S303, the user is authenticated by using the second identity and the password, it is judged whether the authentication is passed, and the procedure in block S104 is performed in response to a determination that the authentication is passed, or the process is terminated in response to a determination that the authentication is not passed.

In an example, the user is authenticated by using the second identity and corresponding password inputted by the user to determine whether the user has the right to bind the first identity with the second identity. This can improve safety of the system, and avoid malicious binding of the second identity in the second website.

In block S104, a relation which associates the first identity with the second identity is established.

In an example, the relation which associates the first identity with the second identity is recorded in a mapping table, and the first identity is a web address.

In an example, the mapping table is established at the background of the second website. The mapping table is capable of recording the relation which associates the first identity with the second identity. In an example, the process of establishing the relation includes a process of writing a field into the established mapping table. For example, when the first identity of a user is user1@gmail.com and the second identity of the user in a website supporting open ID is user1@product1.com, a relation indicating user1@gmail.com→>user1@product1.com is written into the mapping table so that when the user logs into the second website by using user1@gmail.com, the second website regards the user logs into the second website by using user1@product1.com.

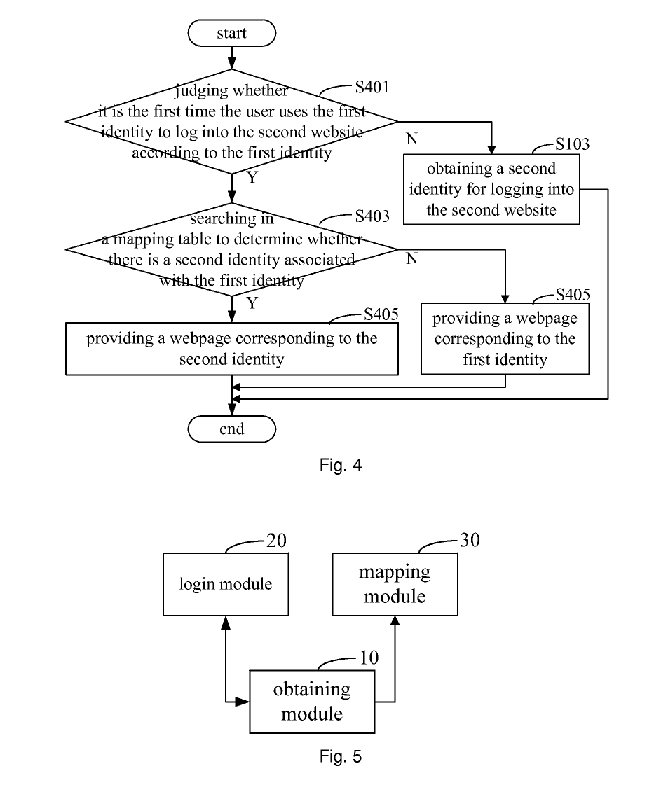

In an example, as shown in FIG. 4, before obtaining the second identity for logging into the second website, the method may also include the following procedures.

In block S401, it is judged whether it is the first time that the user logs into the second website by using the first identity, the procedure in block S103 is performed in response to a determination that it is the first time that the user logs into the second website, or the procedure in block S403 is performed in response to a determination that it is not the first time that the user logs into the second website.

In an example, it is checked whether it is the first time the user uses the first identity to log into the second website after the user have logged into the second website by using the first identity. When it is determined it is the first time the user uses the first identity to log into the second website, it means the user may need to bind the first identity with an original identity of the user in the second website, i.e., the second identity, thus the second identity of the user in the second website is obtained. When it is determined it is not the first time the user uses the first identity to log into the second website, the user is allowed to enter the second website.

In block s403, it is checked whether there is a second identity associated with the first identity in the mapping table, and the procedure in block S405 is performed in response to a determination that the second identity is found, or the procedure in block S407 is performed in response to a determination that the second identity is not found.

In an example, when the user logs into the second website again by using the first identity, the relation that associates the first identity with the second identity may have already been in the mapping table. Therefore, the mapping table is searched to determine whether there is a second identity that is associated with the first identity.

In block S405, a webpage corresponding to the second identity is provided.

In an example, when there is a second identity that is associated with the first identity in the mapping table, a webpage corresponding to the second identity is provided when the user logs into the second website by using the first identity.

In block S407, a webpage corresponding to the first identity is provided.

In an example, when there is no second identity that is associated with the first identity in the mapping table, the user logs into the second website by using the first identity.

It can be seen that the blocks S401-S407 of the above example obtains the second identity of the user in the second website when the user uses the first identity to log into the second website for the first time and establishes a relation which associates the first identity with the second identity, and provides a webpage corresponding to the second identity is provided for the user by searching in the mapping table for the identity associated with the first identity when the user logs into the second website by using the first identity.

Besides the methods provided by the above examples, there may be other methods, e.g., searching in the mapping table when the user logs into the second website by using the first identity, providing the webpage corresponding to the second identity when a relation which associates the first identity with the second identity is found, and obtaining the second identity or providing prompt information to ask the user whether to bind the first identity with another identity when the relation is not found.

FIG. 5 is a schematic diagram illustrating a system for binding identities according to an example of the present disclosure. The system may include an obtaining module 10, a login module 20 and a mapping module 30.

The obtaining module 10 is configured to obtain a first identity which is used for logging into a first website.

In an example, a user registers at a first website to obtain a first identity which is used for logging into the first website. In an example, the first website supports open ID.

The login module 20 is configured to log into a second website by using the first identity.

In a conventional user login system, most websites only support login by users using identities provided by respective websites, i.e., a first identity can only be used for logging into a first website, and a second identity can only be used for logging into a second website, and a user cannot use a uniform identity to log into all of the websites, which is inconvenient for users. In an example of the present disclosure, a first website may be configured to be an open login platform, and a first identity established by the first website is a uniform user identity. A user may log into a second website which supports the open platform by using the first identity, i.e., the user is authenticated by using the first identity provided by the first website to log into the second website. The second website may be a completely different and independent website with respect to the first website, has a different user login system, provides different identities, and supports the open platform of the first website. For example, given the first website provides a register interface for a user and provides an open ID for a user according to register information submitted by the user, the first identity may be in a form of a web address, e.g., a uniform resource location (URL) or an XRL. After registering in a website providing an open ID to obtain a first identity, a user may input the first identity and a password into a second website to log into the second website. The second website may be any website such as Yahoo. The first website serves as an open login platform and provides information for multiple second websites. A user may use the first identity to log into any website supporting the login platform without having to memorize login information for each of the second websites respectively.

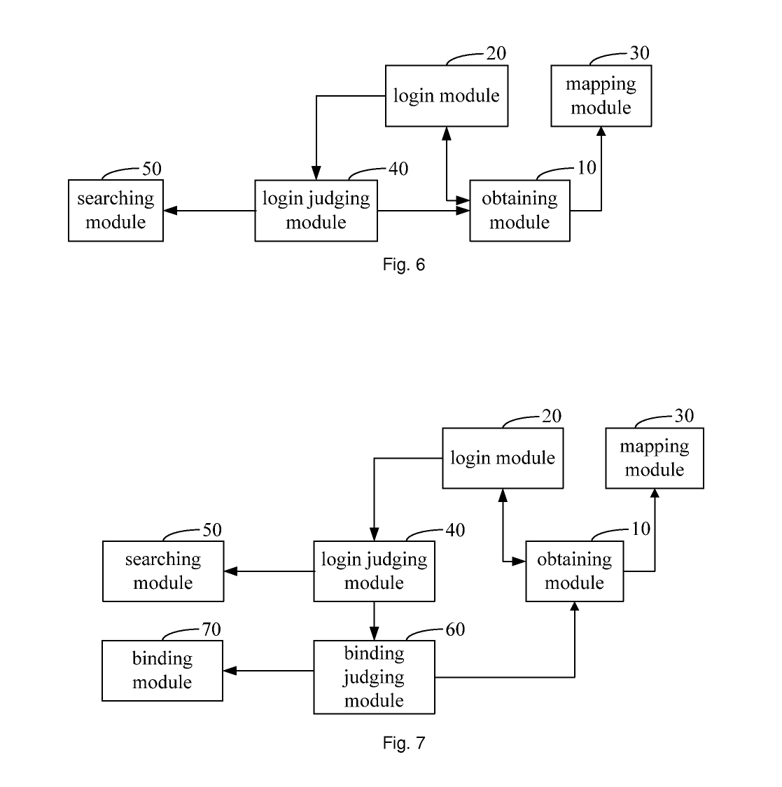

In an example, as shown in FIG. 6, the system may also include a login judging module 40 and a searching module 50.

The login judging module 40 is configured to judge whether it is the first time the user uses the first identity to log into the second website, inform the obtaining module 10 in response to a determination that it is the first time the user uses the first identity to log into the second website, and inform the searching module 50 in response to a determination that it is not the first time the user uses the first identity to log into the second website.

In an example, the login judging module 40 checks whether it is the first time the user uses the first identity to log into the second website after the user have logged into the second website by using the first identity. When it is determined it is the first time the user uses the first identity to log into the second website, it means the user may need to bind the first identity with an original identity of the user in the second website, i.e., the second identity, thus the second identity of the user in the second website is obtained. When it is determined it is not the first time the user uses the first identity to log into the second website, the user may start to visit the second website.

The searching module 50 is configured to search in the mapping table for a second identity associated with the first identity in response to a determination that it is not the first time the user uses the first identity to log into the second website based on the first identity, and provide a webpage corresponding to the second identity in response to a determination that the second identity is found, or provide a webpage corresponding to the first identity in response to a determination that the second identity is not found.

In an example, when the user logs into the second website again by using the first identity, the relation that associates the first identity with the second identity may have already been in the mapping table. Therefore, the searching module 50 may search the mapping table to determine whether there is a second identity that is associated with the first identity.

In an example, as shown in FIG. 7, the system may also include a binding judging module 60 and a binding module 70.

The binding judging module 60 is configured to judge whether the first identity is to be associated with another identity according to a selection of the user, inform the obtaining module 10 in response to a determination that the first identity is to be associated with another identity, or inform the binding module 70 in response to a determination that the first identity is not to be associated with another identity.

In an example, the user may make a selection as to whether identity binding is to be performed in a selection interface provided by the second website. In an example, the binding judging module 60 may make a judgment according to an instruction triggered by a selection of the user. When it is determined that the first identity is to be bound with another identity, the procedure in block S104 is performed to establish a relation which associates the first identity with the second identity. When it is determined that the first identity is not to be bound with another identity, the first identity is directly regarded as the identity of the user in the second website. In an example, after the user is authenticated, a user interface corresponding to the first identity in the second website is provided. The binding judging module 60 may pop up a dialog box for the user. The dialog box may include two buttons, one indicates “auto binding” and the other indicates “binding manually”. When the user selects and clicks on the button indicating “binding manually”, the binding judging module 60 may pop up another dialog box prompting the user to input the second identity. The second identity is an identity of the user originated from the second website. When the user selects and clicks on the button indicating “auto binding”, the second website may take the first identity automatically as the identity of the user in the second website, obtain data associated with the first identity of the user in the first website, and take the data as the data associated with the first identity in the second website so that the user can only log into the second website by using the first identity.

The binding module 70 is configured to obtain data associated with the first identity in the first website, and establish the data in the second website.

In an example, the data records a user name, a nickname and etc. of the user, and can be obtained from registration information of the user in the first website. The first identity serves as a new virtual user of the second website, thus the binding module 70 may obtain data associated with the first identity from the first website. Then the data obtained from the first website is established in the second website so that the first identity has the same user name and nickname in the second website as in the first website.

The obtaining module 10 may be further configured to obtain a second identity of a user for logging into the second website.

In an example, the second identity may be an identity generated after the user registers in the second website. A webpage corresponding to the second identity can be retrieved after a successful login using the second identity in the second website.

In an example, the system may also include an authenticating module which is configured to obtain a password corresponding to the second identity inputted by the user, authenticate the user by using the second identity and the password, judge whether the authentication is passed, inform the mapping module 40 in response to a determination that the authentication is passed, or terminate the process in response to a determination that the authentication is not passed.

In an example, the authenticating module may authenticate the user by using the second identity and corresponding password inputted by the user to determine whether the user has the right to bind the first identity with the second identity. This can improve safety of the system, and avoid malicious binding of the second identity in the second website.

The mapping module 30 may be configured to establish a relation which associates the first identity with the second identity.

In an example, the relation which associates the first identity with the second identity is recorded in a mapping table, and the first identity is a web address.

In an example, the mapping module 30 establishes the mapping table at the background of the second website. The mapping table is capable of recording the relation which associates the first identity with the second identity. In an example, the process of establishing the relation includes a process of writing a field into the established mapping table. For example, when the first identity of a user is user1@gmail.com and the second identity of the user in a website supporting open ID is user1@product1.com, the mapping module 30 writes a relation indicating user1@gmail.com→>user1@product1.com into the mapping table so that when the user logs into the second website by using user1@gmail.com, the second website regards the user logs into the second website by using user1@product1.com.

According to the above method and system that bind identities, when a user logs into a second website by using a first identity, the first identity of the user is associated with a second identity of the user. As such, when the user logs into the second website again, the second identity of the user can be found out by using the first identity. When the first identity is used as a uniform ID in logging into the second website, the website can identity the user using the first identity is the user of the second identity when the user logs into the second website by using the first identity. Therefore, a registered user of a website may use a uniform ID to log into different websites, and it is convenient for a user to log into websites.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute the technical scheme as disclosed herein. Specifically, a system or apparatus having a storage medium which stores machine-readable program codes for implementing functions of any of the above examples and which may make the system or the apparatus (or CPU or MPU) read and execute the program codes stored in the storage medium. In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The above embodiments are merely examples of implementation of the present invention, and may include unnecessary details, thus should not be used for limiting the protection scope of the present invention. It should clear for those skilled in the art that any modification and improvement within the principle of the invention should be covered in the protection scope of the invention. Therefore, the protection scope of the present invention should be determined by the extent defined by the indispensable technical features stated in the claims.

1. A method for processing identity information, comprising:
obtaining a first identity which is used for logging into a first website;
logging into a second website by using the first identity;
obtaining a second identity for logging into the second website;
establishing a relation which associates the first identity with the second identity.

2. The method of claim 1, wherein the relation which associates the first identity with the second identity is recorded in a mapping table, and the first identity is a web address.

3. The method of claim 2, wherein the step of obtaining the second identity for logging into the second website comprises:
obtaining the second identity for logging into the second website in response to a determination that it is the first time a user uses the first identity to log into the second website.

4. The method of claim 2, further comprising:
searching in the mapping table for a second identity associated with the first identity in response to a determination that it is not the first time the user uses the first identity to log into the second website, providing a webpage corresponding to the second identity in response to a determination that the second identity is found, or provide a webpage corresponding to the first identity in response to a determination that the second identity is not found.

5. The method of claim 1, further comprising: before obtaining the second identity for logging into the second website,
obtaining a selection of the user;
judging whether the first identity is to be associated with the second identity according to the selection of the user, performing the step of obtaining the second identity in response to a determination that the first identity is to be associated with the second identity, and obtaining data in the first website associated with the first identity and establishing the data in the second website in response to a determination that the first identity is not to be associated with the second identity.

6. The method of claim 1, further comprising: after obtaining the second identity for logging into the second website and before establishing the relation which associates the first identity with the second identity,
obtaining a password corresponding to the second identity inputted by a user; and
authenticating the user by using the second identity and the password, judging whether the authentication is passed, and performing the step of establishing a relation which associates the first identity with the second identity.

7. A system for processing identity information, comprising a processor and a memory which stores computer-readable instructions to make the processor to perform actions; wherein the memory comprises:
an obtaining module, configured to obtain a first identity which is used for logging into a first website, and obtain a second identity of a user for logging into the second website;
a login module, configured to log into a second website by using the first identity; and
a mapping module, configured to establish a relation which associates the first identity with the second identity.

8. The system of claim 7, wherein
the mapping module is configured to record the relation which associates a web address which serves as the first identity with the second identity into a mapping table.

9. The system of claim 8, wherein the memory further comprises:
a login judging module, configured to judge whether it is the first time the user uses the first identity to log into the second website;
wherein the obtaining module is configured to obtain the second identity for logging into the second website in response to a determination that it is the first time the user uses the first identity to log into the second website.

10. The system of claim 8, wherein the memory further comprises:
a searching module, configured to searching in the mapping table for a second identity associated with the first identity in response to a determination that it is not the first time the user uses the first identity to log into the second website, providing a webpage corresponding to the second identity in response to a determination that the second identity is found, or provide a webpage corresponding to the first identity in response to a determination that the second identity is not found.

11. The system of claim 7, wherein the memory further comprises:
a binding judging module, configured to judge whether the first identity is to be associated with another identity according to a selection of the user, instruct the obtaining module to obtain the second identity of the user for logging into the second website in response to a determination that the first identity is to be associated with another identity, or inform an associating module in response to a determination that the first identity is not to be associated with another identity;
wherein the associating module is configured to obtain data associated with the first identity in the first website and establish the data in the first website after being informed by the binding judging module.

12. The system of claim 7, wherein the memory further comprises:
an authenticating module, configured to obtain a password inputted by the user corresponding to the second identity, authenticate the user by using the second identity and the password, judge whether the authentication is passed, and inform the mapping module to establish a relation which associates the first identity with the second identity in response to a determination that the authentication is passed.
